(19) United States
(12) Patent Application Publication
(10) Pub. No.: US 2024/0212928 A1
(43) Pub. Date: Jun. 27, 2024

(54) PERMANENT MAGNET RECOVERY DEVICE AND PERMANENT MAGNET RECOVERY METHOD

(71) Applicant: HONDA MOTOR CO., LTD., Tokyo (JP)

(72) Inventors: Satoshi OYAMA, Saitama (JP); Katsuya YAMAICHI, Saitama (JP)

(21) Appl. No.: 18/491,822

(22) Filed: Oct. 23, 2023

(30) Foreign Application Priority Data
Dec. 26, 2022 (CN) 202211677696.2

(51) Int. Cl. H01F 41/02

(52) U.S. Cl. CPC H01F 41/0253

(57) ABSTRACT

Provided are a permanent magnet recovery device that make it possible to recover a permanent magnet from a permanent magnet holder through microwave heating, while preventing uneven heating inside the permanent magnet holder even in a case where a resin material having a low microwave absorption rate is used as an adhesive in the permanent magnet holder. A permanent magnet recovery device includes: a heat treatment furnace that accommodates a permanent magnet holder including a laminated steel sheet having an insulating film and a permanent magnet attached to the laminated steel sheet via a resin material, the permanent magnet holder having heat insulators attached thereto in such a manner that the heat insulators are in contact at least with the resin material in opposite end portions of the permanent magnet holder in a lamination direction of the laminated steel sheet; and a microwave generator that emits microwaves into the heat treatment furnace.

This application is based on and claims the benefit of priority from Chinese Patent Application No. 202211677696.2, filed on 26 Dec. 2022, the content of which is incorporated herein by reference.

### BACKGROUND OF THE INVENTION

### Field of the Invention

The present invention relates to a permanent magnet recovery device and a permanent magnet recovery method.

### Related Art

In recent years, efforts have been intensifying towards a significant reduction in waste generation through waste prevention, reduction, recycling, and reuse. In pursuit of this goal, research and development regarding the recycling of permanent magnets are being conducted. A technique has been devised to disassemble a magnetic circuit structure including laminated steel sheets having permanent magnets fixed thereto with an adhesive, such as a rotor of a rotating electrical machine, and thus recover the permanent magnets (see, for example, Japanese Unexamined Patent Application, Publication No. 2001-85223). In the technique disclosed in Japanese Unexamined Patent Application, Publication No. 2001-85223, the magnetic circuit structure is heated to a high temperature in a heavy oil furnace to carbonize the adhesive, so that the permanent magnets are recovered. Another technique has been devised to raise the temperature of a laminated steel sheet covered with an adhesive coating through microwave heating, and thus enhance adhesiveness of the adhesive coating (see, for example, Japanese Unexamined Patent Application, Publication No.H11-234972).
Patent Document 1: Japanese Unexamined Patent Application, Publication No. 2001-85223
Patent Document 2: Japanese Unexamined Patent Application, Publication No.H11-234972

### SUMMARY OF THE INVENTION

Some permanent magnets are expensive, and recovering such permanent magnets without degrading their original properties is a challenge to be addressed in the techniques related to the recycling of permanent magnets. In the technique disclosed in Japanese Unexamined Patent Application, Publication No. 2001-85223, the magnetic circuit structure is heated to a high temperature in a heavy oil furnace to purposely neutralize the permanent magnets, so that the permanent magnets can be safely recovered. However, these expensive permanent magnets are exposed to high temperatures for a long period of time, leading to development of cracks and oxidation in the permanent magnets to be recovered. Due to resulting property degradation, it is impossible to remagnetize the permanent magnets as is, resulting in significant losses in terms of resource reuse. The technique disclosed in Japanese Unexamined Patent Application, Publication No. H11-234972 is specifically aimed at strengthening the bonding between layers of the laminated steel sheet. This technique therefore lacks consideration of the viewpoint concerning the recovery of specific recyclable items, such as permanent magnets, from a magnetic circuit structure. Consequently, the technique is not suited for recycling purposes as is.

In view of the above-described circumstances, the applicant has proposed a permanent magnet recovery device and a permanent magnet recovery method that make it possible to recover a permanent magnet attached, via a resin material, to a laminated steel sheet having an insulating film, while preventing property degradation (Japanese Patent Application No. 2021-214038). Successfully recovering a permanent magnet without degrading properties thereof allows for reuse of the permanent magnet. This, in turn, reduces the need for new permanent magnet production, achieving a reduction in environmental burdens such as a reduction in carbon dioxide emissions.

In the foregoing proposal by the applicant, for example, a rotor of a rotating electrical machine is configured as a permanent magnet holder in which a permanent magnet is attached, via a resin material, to a laminated steel sheet having an insulating film, and a high-frequency wave absorbent is attached to each end portion of the permanent magnet holder in a lamination direction of the laminated steel sheet so as to contact at least the resin material. When the permanent magnet holder is heated with microwaves to recover the permanent magnet, not only the resin material inside the permanent magnet holder but also the high-frequency wave absorbent at each end portion is heated thoroughly without temperature variations. As a result, the adhesive force of the resin material provided to function as an adhesive is rendered ineffective, and the permanent magnet can be removed easily. The permanent magnet itself does not experience a significant temperature increase. Thus, it is possible to recover the permanent magnet without degrading properties as a permanent magnet.

Resin materials that can serve as an adhesive in permanent magnet holders exhibit different microwave absorption rates depending on their types. In the case of a permanent magnet holder including a resin material having a lower microwave absorption rate, only the high-frequency wave absorbent located in a portion around the outer surface is heated to result in non-uniform temperature distribution in an inner portion, causing so-called uneven heating. A resulting problem is that the efficiency of heating across the entire permanent magnet holder is low, and short-duration heating is insufficient to demagnetize the permanent magnet, requiring a separate demagnetization process.

In order to solve the above-described problem, the present invention aims to provide a permanent magnet recovery device and a permanent magnet recovery method that make it possible to recover a permanent magnet from a permanent magnet holder through microwave heating, while preventing uneven heating inside the permanent magnet holder even in a case where a resin material having a low microwave absorption rate is used as an adhesive in the permanent magnet holder. The present invention also aims to make it possible to recover a permanent magnet with minimized cracks and oxidation while demagnetizing the permanent magnet, thereby contributing to a significant reduction in waste generation.
(1) A permanent magnet recovery device (for example, a permanent magnet recovery device 1 described below) including: a heat treatment furnace (for example, a heat treatment furnace 2 described below) that accommodates a permanent magnet holder (for example, a permanent magnet holder 5 described below) including a laminated steel sheet (for example, a laminated steel sheet 6 described below) having an insulating film and a permanent magnet (for example, a permanent magnet 8 described below) attached to the laminated steel sheet via a resin material (for example, a resin material 7 described below), the permanent magnet holder having microwave-transmitting heat insulators (for example, heat insulators 10 described below) attached thereto in such a manner that the heat insulators are in contact at least with the resin material in opposite end portions of the permanent magnet holder in a lamination direction of the laminated steel sheet; and a microwave generator (for example, a microwave generator 3 described below) that emits microwaves into the heat treatment furnace.
(2) The permanent magnet recovery device according to (1), wherein the heat insulators have a greater microwave penetration depth than the resin material.
(3) The permanent magnet recovery device according to (2), wherein the resin material is an epoxy resin, and the heat insulators are alumina-based or silica-based heat insulators having a thickness of less than or equal to 50 mm.
(4) A permanent magnet recovery method including: a heat insulator attachment step (for example, a heat insulator attachment step S1 described below) for attaching microwave-transmitting heat insulators (for example, heat insulators 10 described below) to a permanent magnet holder (for example, a permanent magnet holder 5 described below) including a laminated steel sheet (for example, a laminated steel sheet 6 described below) having an insulating film and a permanent magnet (for example, a permanent magnet 8 described below) attached to the laminated steel sheet via a resin material (for example, a resin material 7 described below), in such a manner that the heat insulators are in contact at least with the resin material in opposite end portions of the permanent magnet holder in a lamination direction of the laminated steel sheet; and a microwave heating step (for example, a microwave heating step S2 described below) for heating, in a microwave heating furnace (for example, a microwave heating furnace 4 described below), the permanent magnet holder having the heat insulators attached thereto in the heat insulator attachment step.
(5) The permanent magnet recovery method according to (4), wherein in the heat insulator attachment step, heat insulators having a greater microwave penetration depth than the resin material are attached to the opposite end portions of the permanent magnet holder in the lamination direction of the laminated steel sheet.
(6) The permanent magnet recovery method according to (5), wherein the resin material is an epoxy resin, and the heat insulators are alumina-based or silica-based heat insulators having a thickness of less than or equal to 50 mm.

In the permanent magnet recovery device according to (1), the microwave-transmitting heat insulators suppress heat dissipation from end portions of the laminated steel sheet, where the microwave heating is relatively difficult to progress, while avoiding hindering microwaves from penetrating to the inside of the resin material, which functions as an adhesive, in the end portions. As a result, a uniform temperature distribution is achieved inside the permanent magnet holder, promoting thorough heating. That is, uneven heating across the entire permanent magnet holder is prevented, improving the heating efficiency. As a result, the permanent magnet is also uniformly heated through the resin material serving as an adhesive in the permanent magnet holder. The above-described configuration therefore makes it possible to render the adhesive function of the resin material ineffective and recover the permanent magnet with minimized cracks and oxidation while quickly demagnetizing the permanent magnet, thereby contributing to a significant reduction in waste generation. Furthermore, the above-described configuration makes it possible to save power for the heating, achieving a reduction in environmental burdens such as a reduction in carbon dioxide emissions.

In the permanent magnet recovery device according to (2), the heat insulators have a greater microwave penetration depth than the resin material. This configuration reduces the amount of microwaves to be absorbed by the heat insulators and allows for efficient heating of the resin material serving as an adhesive.

In the permanent magnet recovery device according to (3), the heat insulators have a size set so that the thickness thereof does not exceed 50 mm where the heat insulating effect saturates. This configuration helps avoid wastage of the heat insulators.

In the permanent magnet recovery method according to (4), the microwave-transmitting heat insulators suppress heat dissipation from end portions of the laminated steel sheet, where the microwave heating is relatively difficult to progress, while avoiding hindering microwaves from penetrating to the inside of the resin material, which functions as an adhesive, in the end portions. As a result, a uniform temperature distribution is achieved inside the permanent magnet holder, promoting thorough heating. That is, uneven heating across the entire permanent magnet holder is prevented, improving the heating efficiency. As a result, the permanent magnet is also uniformly heated through the resin material serving as an adhesive in the permanent magnet holder. The above-described configuration therefore makes it possible to render the adhesive function of the resin material ineffective and recover the permanent magnet with minimized cracks and oxidation while quickly demagnetizing the permanent magnet, thereby contributing to a significant reduction in waste generation. Furthermore, the above-described configuration makes it possible to save power for the heating, achieving a reduction in environmental burdens such as a reduction in carbon dioxide emissions.

In the permanent magnet recovery method according to (2), the heat insulators have a greater microwave penetration depth than the resin material. This configuration reduces the amount of microwaves to be absorbed by the heat insulators and allows for efficient heating of the resin material serving as an adhesive.

In the permanent magnet recovery method according to (6), the heat insulators have a size set so that the thickness thereof does not exceed 50 mm where the heat insulating effect saturates. This configuration helps avoid wastage of the heat insulators.

### BRIEF DESCRIPTION OF THE DRAWINGS

FIG. 1 is a conceptual diagram illustrating a permanent magnet recovery device according to an embodiment of the present invention;

FIG. 2 is a diagram for describing a heat insulator attachment step in a permanent magnet recovery method according to the embodiment of the present invention;

FIG. 3 is a diagram for use in selection of a heat insulator applicable to the embodiment of the present invention;

FIG. 4 is a diagram for describing steps of the permanent magnet recovery method according to the embodiment of the present invention; and

FIG. 5 is a diagram showing the relationship between the heat insulating effect and the thickness of heat insulators applicable to the embodiment of the present invention.

### DETAILED DESCRIPTION OF THE INVENTION

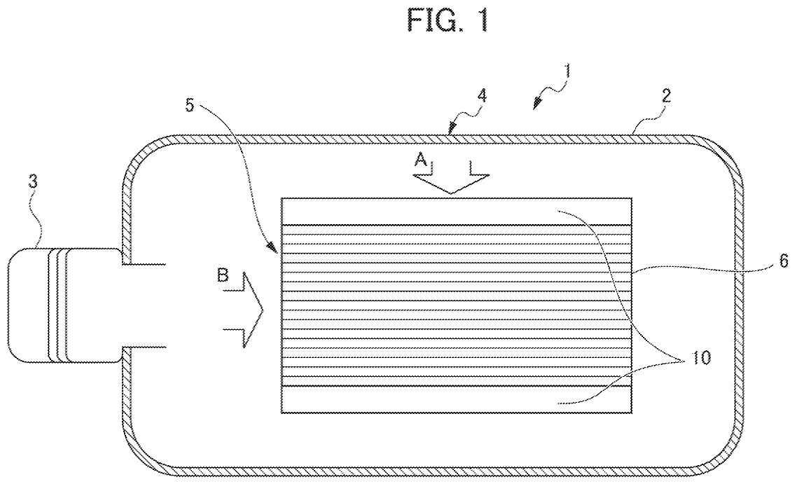

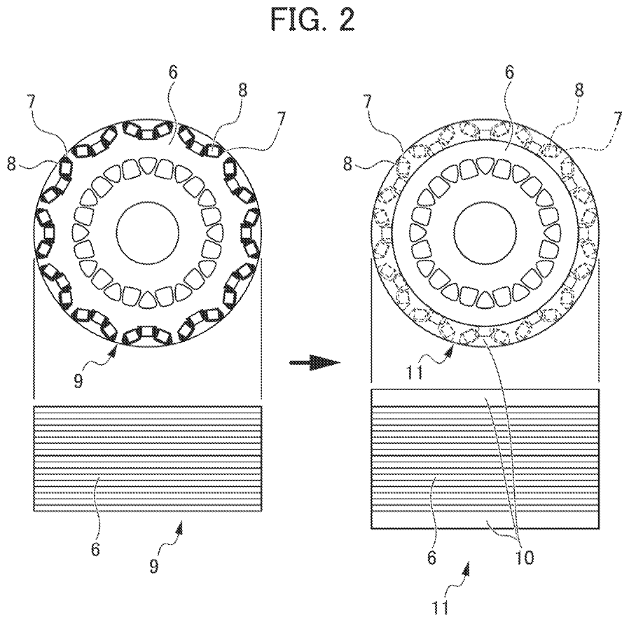

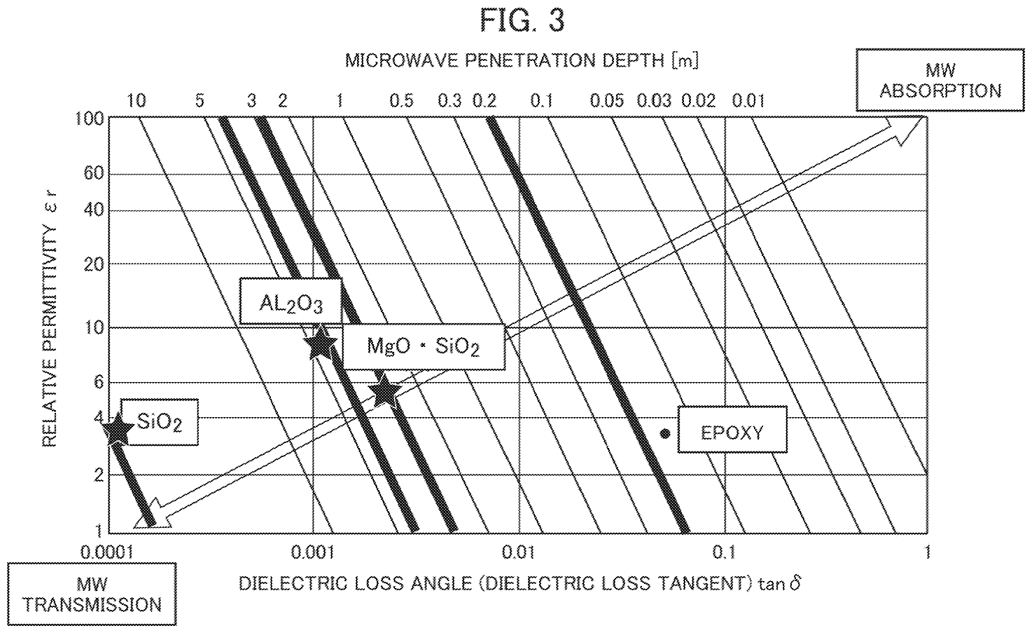

The following describes an embodiment of the present invention with reference to the accompanying drawings. In the drawings mentioned below, the same or corresponding elements are labeled with the same reference numerals. FIG. 1 is a conceptual diagram illustrating a permanent magnet recovery device 1 according to the embodiment of the present invention. FIG. 2 is a diagram for describing a heat insulator attachment step in a permanent magnet recovery method according to the embodiment of the present invention. FIG. 3 is a diagram for describing steps of the permanent magnet recovery method according to the embodiment of the present invention.

The permanent magnet recovery device 1 according to the embodiment of the present invention includes a heat treatment furnace 2 that heats a treatment object and a microwave generator 3 that emits microwaves into the heat treatment furnace 2. The microwave generator 3 includes, for example, a magnetron and a waveguide. The heat treatment furnace 2 and the microwave generator 3 form a microwave heating furnace 4. As a treatment object to be heated, a particular permanent magnet holder 5 is accommodated in the heat treatment furnace 2 of the microwave heating furnace 4. The microwave heating furnace 4 having the permanent magnet holder 5 accommodated therein constitutes a form of the permanent magnet recovery device 1.

The permanent magnet holder 5 includes a laminated steel sheet 6 having insulating films and permanent magnets 8 attached to the laminated steel sheet 6 via a resin material 7. The permanent magnet holder 5 is, for example, a rotor 9 of a disassembled rotating electrical machine. This rotor 9 is a permanent magnet embedded rotor, and is also referred to as an interior permanent magnet (IPM) rotor. In the IPM rotor, a number of expensive high-performance rare-earth magnets are held.

As shown in FIG. 2, heat insulators 10 are attached to predetermined locations on the rotor 9, which is the permanent magnet holder 5. In this example, microwave-transmitting heat insulators 10 are attached to the permanent magnet holder 5 in such a manner that the heat insulators 10 are in contact at least with the resin material 7 in opposite end portions of the permanent magnet holder 5 in the lamination direction of the laminated steel sheet 6. As a result, the rotor 9 is formed into a treatment object 11 having a predetermined form in which the heat insulators 10 are attached to peripheral edge regions of the rotor 9 at both end surfaces in an axial direction of the rotor 9.

A material having a greater microwave penetration depth than the resin material serving as an adhesive is used as the heat insulators 10. A suitable material for such heat insulators 10 is selected by considering a diagram representing the relationship between relative permittivity, dielectric loss angle, and microwave penetration depth (microwave frequency 2450 MHz) of each material, as shown in FIG. 3. The microwave penetration depth is the distance at which the power density of irradiated electromagnetic waves decreases by half, and is also referred to as the half-power depth.

“MW” in FIG. 3 stands for microwave. A bidirectional arrow between “MW transmission” and “MW absorption” indicates that a material having a greater microwave penetration depth transmits microwaves more easily. A material that transmits microwaves more easily experiences less temperature rise as the time of microwave irradiation progresses and is more suitable for the heat insulators 10. A material suitable for the heat insulators 10 is selected by also considering heat resistance and toxicity of each material in addition to the microwave penetration depth described above. An epoxy resin is used as the resin material according to the embodiment of the present invention. As a result of evaluating materials having a microwave penetration depth at least ten times greater than that of the epoxy resin by considering durability and toxicity thereof, alumina-based or silica-based heat insulators, such as alumina (AL₂O₃), quartz (SiO₂), and steatite (MgO·SiO₂), are determined to be suitable as the material for the heat insulators 10.

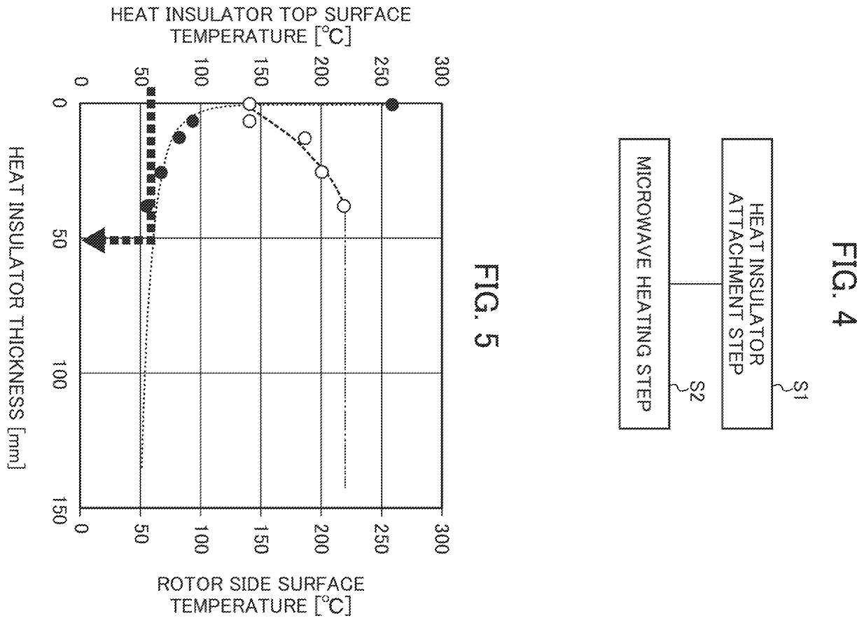

The following describes the permanent magnet recovery method according to the embodiment of the present invention. FIG. 4 is a diagram for describing steps of the permanent magnet recovery method according to the embodiment of the present invention. As shown in FIG. 4, this permanent magnet recovery method includes a heat insulator attachment step S1 and a microwave heating step S2. The heat insulator attachment step S1 is a step for forming the rotor 9 shown in FIG. 2 into the treatment object 11. In the subsequent microwave heating step S2, the treatment object 11 is placed in the heat treatment furnace 2 of the microwave heating furnace 4 and heated with microwaves from the microwave generator 3.

The progress of the heating of the treatment object 11 can be estimated, for example, by measuring the top surface temperature of the treatment object 11 from a direction facing the upper end surface of the treatment object 11 as indicated by an arrow A in FIG. 1, and measuring the side surface temperature of the treatment object 11 from a direction facing the outer circumferential surface of the treatment object 11 as indicated by an arrow B, using a radiation thermometer, not shown.

As long as an appropriate material is used as the heat insulators 10 on the laminated steel sheet 6 of the treatment object 11, the top surface temperature and the side surface temperature of the treatment object 11 exhibit the following trends as the time of microwave irradiation progresses. That is, the side surface temperature of the treatment object 11 rises relatively rapidly and reaches a relatively high value, whereas the top surface temperature of the treatment object 11 rises relatively slowly and remains at a relatively low value. When the top surface temperature and the side surface temperature of the treatment object 11 transition while exhibiting the trends described above as the time of microwave irradiation progresses, and the side surface temperature eventually exceeds 175° C., for example, the inside of the treatment object 11 can be estimated to have been heated evenly to a temperature high enough to render the adhesive function of the resin material ineffective.

The present inventors conducted an experiment and observed, as a result, that the heat insulating effect of the heat insulators 10 depends on the thickness thereof, but reaches saturation once the thickness reaches a certain value. FIG. 5 is a diagram showing the relationship between the thickness of the heat insulators 10, and the top surface temperature and the side surface temperature of the treatment object 11 heated with microwaves. In the experiment, an epoxy resin was used as the resin material, and alumina-based heat insulators were used as the heat insulators. As shown in FIG. 5, the heat insulating effect increases with an increase in the thickness of the heat insulators 10, keeping the top surface temperature relatively low, but shifts toward saturation tendency once the thickness reaches 50 mm. That is, increasing the thickness of the heat insulators 10 beyond 50 mm does not increase the heat dissipation suppression effect. It is therefore estimated that the side surface temperature, which reflects the internal temperature of the treatment object 11, increases until the thickness of the heat insulators 10 reaches 50 mm, but beyond a thickness of 50 mm, reaches a saturation point due to increased heat dissipation. It is therefore appropriate to set the thickness of the heat insulators 10 to 50 mm in order to ensure the heat insulating effect while avoiding wastage of the heat insulators.

The permanent magnet recovery device and the permanent magnet recovery method according to the present embodiment produce the following advantageous effects.

The permanent magnet recovery device 1 according to (1) includes: the heat treatment furnace 2 that accommodates the permanent magnet holder 5 including the laminated steel sheet 6 having insulating films and the permanent magnets 8 attached to the laminated steel sheet 6 via the resin material 7, the permanent magnet holder 5 having the microwave-transmitting heat insulators 10 attached thereto in such a manner that the heat insulators 10 are in contact at least with the resin material 7 in the opposite end portions of the permanent magnet holder 5 in the lamination direction of the laminated steel sheet 6; and the microwave generator 3 that emits microwaves into the heat treatment furnace 2. With this configuration, the microwave-transmitting heat insulators 10 suppress heat dissipation from end portions of the laminated steel sheet 6, where the microwave heating is relatively difficult to progress, while avoiding hindering microwaves from penetrating to the inside of the resin material 7, which functions as an adhesive, in the end portions. As a result, a uniform temperature distribution is achieved inside the permanent magnet holder 5, promoting thorough heating. As a result, the permanent magnets 8 are also uniformly heated through the resin material 7 serving as an adhesive in the permanent magnet holder 5. The above-described configuration therefore makes it possible to render the adhesive function of the resin material 7 ineffective and recover the permanent magnets 8 with minimized cracks and oxidation while quickly demagnetizing the permanent magnets 8, thereby contributing to a significant reduction in waste generation. Furthermore, the above-described configuration makes it possible to save power for the heating, achieving a reduction in environmental burdens such as a reduction in carbon dioxide emissions.

In the permanent magnet recovery device 1 according to (2), the heat insulators 10 have a greater microwave penetration depth than the resin material 7. This configuration reduces the amount of microwaves to be absorbed by the heat insulators 10 and allows for efficient heating of the resin material 7 serving as an adhesive.

In the permanent magnet recovery device according to (3), the heat insulators 10 have a size set so that the thickness thereof does not exceed 50 mm where the heat insulating effect saturates. This configuration helps avoid wastage of the heat insulators 10.

The permanent magnet recovery method according to (4) includes: the heat insulator attachment step S1 for attaching the microwave-transmitting heat insulators 10 to the permanent magnet holder 5 including the laminated steel sheet 6 having insulating films and the permanent magnets 8 attached to the laminated steel sheet 6 via the resin material 7, in such a manner that the heat insulators 10 are in contact at least with the resin material 7 in the opposite end portions of the permanent magnet holder 5 in the lamination direction of the laminated steel sheet 6; and the microwave heating step S2 for heating, in the microwave heating furnace 4, the permanent magnet holder 5 having the heat insulators 10 attached thereto in the heat insulator attachment step S1. With this configuration, the microwave-transmitting heat insulators 10 suppress heat dissipation from end portions of the laminated steel sheet 6, where the microwave heating is relatively difficult to progress, while avoiding hindering microwaves from penetrating to the inside of the resin material 7, which functions as an adhesive, in the end portions. As a result, a uniform temperature distribution is achieved inside the permanent magnet holder 5, promoting thorough heating. That is, uneven heating across the entire permanent magnet holder 5 is prevented, improving the heating efficiency. The above-described configuration therefore makes it possible to render the adhesive function of the resin material 7 ineffective and recover the permanent magnets 8 with minimized cracks and oxidation while quickly demagnetizing the permanent magnets 8, thereby contributing to a significant reduction in waste generation. Furthermore, the above-described configuration makes it possible to save power for the heating, achieving a reduction in environmental burdens such as a reduction in carbon dioxide emissions.

In the permanent magnet recovery method according to (5), the heat insulators 10 have a greater microwave penetration depth than the resin material 7. This configuration reduces the amount of microwaves to be absorbed by the heat insulators 10 and allows for efficient heating of the resin material 7 serving as an adhesive.

In the permanent magnet recovery method according to (6), the heat insulators 10 have a size set so that the thickness thereof does not exceed 50 mm where the heat insulating effect saturates. This configuration helps avoid wastage of the heat insulators 10.

An embodiment of the present invention has been described above. However, the present invention is not limited to the embodiment. Some portions of the embodiment may be changed as appropriate within the scope of the gist of the present invention. For example, the embodiment has been described using an example in which the permanent magnet holder is a rotor of a rotating electrical machine and the permanent magnets are recovered from such a rotor. However, the present invention may be applied to a case where the permanent magnet holder is a medical instrument including permanent magnets and the permanent magnets are recovered from such a medical instrument.

### EXPLANATION OF REFERENCE NUMERALS

1: Permanent magnet recovery device
2: Heat treatment furnace
3: Microwave generator
4: Microwave heating furnace
5: Permanent magnet holder
6: Laminated steel sheet
7: Resin material
8: Permanent magnet
9: Rotor
10: Heat insulator
11: Treatment object

What is claimed is:

1. A permanent magnet recovery device comprising:
a heat treatment furnace that accommodates a permanent magnet holder including a laminated steel sheet having an insulating film and a permanent magnet attached to the laminated steel sheet via a resin material, the permanent magnet holder having microwave-transmitting heat insulators attached thereto in such a manner that the heat insulators are in contact at least with the resin material in opposite end portions of the permanent magnet holder in a lamination direction of the laminated steel sheet; and
a microwave generator that emits microwaves into the heat treatment furnace.

2. The permanent magnet recovery device according to claim 1, wherein the heat insulators have a greater microwave penetration depth than the resin material.

3. The permanent magnet recovery device according to claim 2, wherein the resin material is an epoxy resin, and the heat insulators are alumina-based or silica-based heat insulators having a thickness of less than or equal to 50 mm.

4. A permanent magnet recovery method comprising:
a heat insulator attachment step for attaching microwave-transmitting heat insulators to a permanent magnet holder including a laminated steel sheet having an insulating film and a permanent magnet attached to the laminated steel sheet via a resin material, in such a manner that the heat insulators are in contact at least with the resin material in opposite end portions of the permanent magnet holder in a lamination direction of the laminated steel sheet; and
a microwave heating step for heating, in a microwave heating furnace, the permanent magnet holder having the heat insulators attached thereto in the heat insulator attachment step.

5. The permanent magnet recovery method according to claim 4, wherein in the heat insulator attachment step, heat insulators having a greater microwave penetration depth than the resin material are attached to the opposite end portions of the permanent magnet holder in the lamination direction of the laminated steel sheet.

6. The permanent magnet recovery method according to claim 5, wherein the resin material is an epoxy resin, and the heat insulators are alumina-based or silica-based heat insulators having a thickness of less than or equal to 50 mm.
